(19) United States
(12) Patent Application Publication
(10) Pub. No.: US 2002/0186252 A1
(43) Pub. Date: Dec. 12, 2002

(54) Method, apparatus and computer program product for providing context to a computer display window

(75) Inventors: Maria Azua Himmel, Yorktown Heights, NY (US); Herman Rodriguez, Austin, TX (US); Newton James Smith JR., Austin, TX (US); Clifford Jay Spinac, Austin, TX (US)

Correspondence Address: International Business Machines Corporation, Intellectual Property Law Department,, Internal Zip 4054, 11400 Burnet Road, Austin, TX, 78758, US

(73) Assignee: International Business Machines Corporation, Armonk, NY (US)

(21) Appl. No.: 09/875,956

(22) Filed: Jun. 7, 2001

(51) Int. Cl. G09G 5/00

(52) U.S. Cl. 345/787

(57) ABSTRACT

A first portion of certain information is displayed in a window of a computerized display device. The window includes a scroll bar to control scrolling of the window through the information. The information includes a succession of objects. Context is indicated for the information by displaying indicators representing respective ones of the objects, including ones of the objects that are outside the first portion of the information that is displayed in the window. The indicators are displayed in an area of the window, including an area within the scroll bar. In another aspect, positions of the indicators represent relative positions of the objects within the information. In a still further aspect, displayed attributes of the indicators represent the type of the objects represented by the respective indicators.

### CROSS-REFERENCE TO RELATED APPLICATION

This present application is related to the following co-pending application which has been filed on the same date as the present application, is assigned to the same assignee as the present application and is hereby incorporated herein by reference:

Application No.______ (Applicant's docket AUS9-2001-0157-US1), “METHOD, APPARATUS AND COMPUTER PROGRAM PRODUCT FOR CONTEXT-SENSITIVE SCROLLING.”

### FIELD OF THE INVENTION

This invention relates to displaying information on a computerized device, and more particularly to displaying indications about what information is outside or inside the information in a display window.

### BACKGROUND

People are viewing more and more information, particularly Internet web pages, directly on computer displays. Web browsing is now possible with small computerized devices such as personal digital assistants and cell phones. Small computerized devices for reading books are also gaining in popularity. On computer displays, especially small ones, it is difficult for a user to maintain a sense of the context of the information displayed, since so little information fits in the display window. Therefore there is an increasing need for mechanisms which help users maintain their sense of the context of the information displayed on computerized display devices.

### SUMMARY

The present invention involves a recognition that the foregoing need is addressed by selectively displaying indications about what information is outside or inside the information in a computerized device's display window. That is, in computerized devices a computer program such as a word processing application, a web browser, etc., generates data for a display device. Information, or more precisely a selected portion of the information, is displayed in a window of the display. The information may be such as a word processing document, an Internet web page, etc. According to the present invention, since only a small portion of the information fits in the display window of a computerized device, particularly a small device, indicators are displayed representing information that is outside or inside the portion of information in the window. This advantageously provides a summary view to help the user understand the context of the portion of the information that is displayed in the window.

In one aspect, the window includes a scroll bar used for scrolling the window through the information, responsive to user commands from an input device, and the indicators are displayed within the scroll bar. In a further aspect, indicators are displayed in the scroll bar for information that is outside the window, while indicators are displayed in the slider for information that is within the window.

In another aspect, positions of the indicators represent relative positions of objects within the information. The objects represented are of numerous different object types, including paragraphs of text, tables, images, audio content, video content and hyper links. Such objects include sub-objects. For example, paragraphs of text include sentences, while spreadsheets, for example, include tables, cells, rows and columns. In a further aspect, a displayed attribute of an indicator represents the type of the indicator's respective object. This advantageously provides substantial further contextual detail, without using much display space.

Other objects and advantages of the invention will become apparent upon reading the following detailed description and upon reference to the accompanying drawings.

### BRIEF DESCRIPTION OF THE DRAWINGS

FIG. 1 illustrates a window in three different positions as the window scrolls through information, in accordance with an embodiment of the present invention.

FIG's 2A and 2B illustrate the window in the first two of the positions again, according to another embodiment, and also show additional details about the scroll bar.

FIG's 3A and 3B illustrate the window in the same two positions as in FIG's 2A and 2B for yet another embodiment.

FIG. 4 illustrates the window in the third position, in which a table object is in the view of the window, and illustrates an enlarged view of the slider, according to an embodiment.

FIG. 5 illustrates a computerized device for displaying and scrolling through information, in accordance with an embodiment of the present invention.

FIG. 6 illustrates how information about an object can be made to pop up in an enlarged view of the object, in accordance with an embodiment of the present invention.

### DETAILED DESCRIPTION

The claims at the end of this application set out novel features which applicants believe are characteristic of the invention. The invention, a preferred mode of use, further objectives and advantages, will best be understood by reference to the following detailed description of an illustrative embodiment read in conjunction with the accompanying drawings.

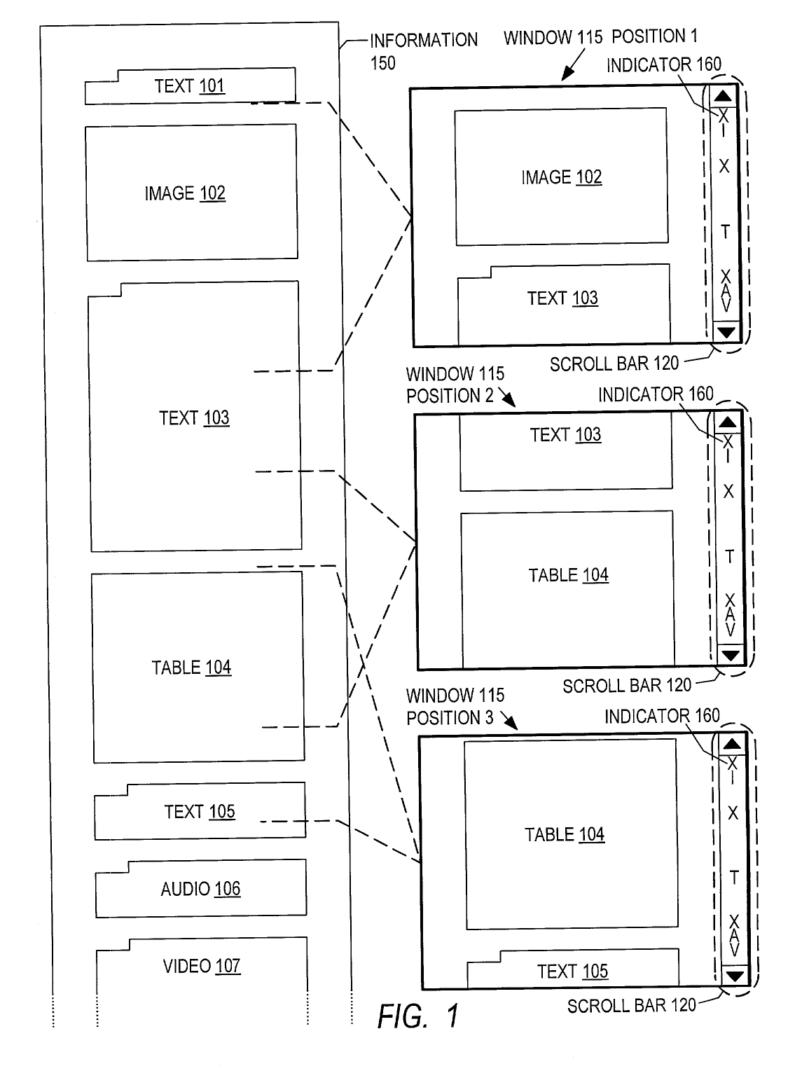

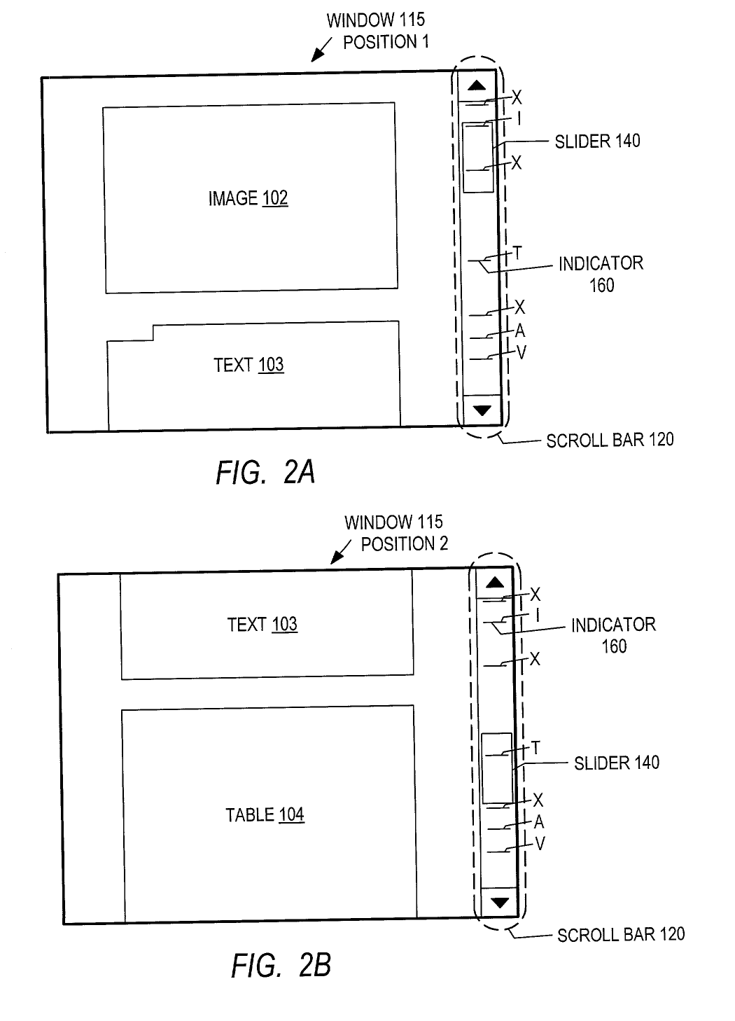

FIG. 1 illustrates a display window 115 in first, second and third positions. The window 115 moves to these positions responsive to user scrolling commands. It should be a understood that these positions do not necessarily correspond to positions that would arise from context sensitive scrolling, as described in the related application. These positions were selected for illustration purposes.

As the window moves, it scrolls through information 150. (Herein reference is made to the window moving, that is scrolling, through the information. It should be understood that movement of the window and information is relative, and that moving the window relative to the information may be considered equivalent to moving the information relative to the window.) The information 150 includes a succession of objects 101, 102, 103, etc. The objects are of various types. The first object 101 in the illustration is a text object, such as a paragraph. The next object 102 is an image. The next object 103 is more text. The fourth object 104 is a table, which has rows and columns (rows and columns not shown). The fifth object 105 is text. The sixth object 106 is an audio clip. The seventh object 107 is a video clip.

With the window 115 in the first position, a first portion of the information 150 is shown in the window 115, including all of object 102 and a top part of object 103. (It should be understood that the position referred to here as position 1 has been selected for the sake of illustration. The illustrated starting position could have at been any number of different locations.) The window 115 includes a scroll bar 120 for controlling scrolling of the window 115 through the information 150. In order to more clearly illustrate certain initial aspects of the embodiment in this FIG. 1, details of the scroll bar 120 are not shown, although the scroll bar does also include a slider that is shown in the subsequent FIG's.

Within the window 115, indicators 160 representing respective ones of the objects 101, 102 etc. are displayed. This includes indicators for objects such as 101 and 104 that are outside the portion of the information that is currently displayed in the window. In particular, in this embodiment the indicators 160 are displayed in the scroll bar 120 area of the window. An attribute of such an indicator 160 is displayed, indicating the type of object that the indicator 160 represents. In FIG. 1 the indicators are shown as letters, where the letter “X” represents a text type object, the letter “I” represents an image type object, and the letter “T” represents a table type object. The letter symbol for an indicator 160 may be referred to herein as an “attribute” of the indicator 160. In different embodiments the indicators may have a different appearance than what is shown in FIG. 1. In one embodiment the indicators are icons. For example, in one embodiment the indicator 160 for the audio clip 106 is an icon that looks like an audio speaker.

Positions of the indicators 160 represent relative positions of the objects 101, 102 etc., within the information 150. That is, not only does the sequence of the indicators 160 in the scroll bar 120 indicate the sequence of the objects 101, 102, etc., but the relative locations of the indicators within the scroll bar 120, including the space between the indicators, has significance as well. The first object 101 is at the top of the information 150, and therefore for the position of the window 115 shown in FIG. 1, the first object is represented by the top “X” indicator in the scroll bar 120. Also, the first object 101 is relatively small in comparison to the image object 102, represented by the next indicator down in the scroll bar, shown as an “I.” While the image object 102 is somewhat larger than the text object 101, it is smaller than the text object 103, which is represented by the third indicator down in the scroll bar, shown as another “X.” Therefore there is relatively less space between the top “X” indicator in the scroll bar 120 and the second indicator down in the scroll bar 120 than there is between the third and fourth indicators.

With the window 115 in the second position, the bottom portion of object 103 is displayed in the upper portion of the window 115. Also displayed with the window 115 in this position is the top part of object 104, shown in the bottom portion of the window 115.

In the third position, table object 104 is in the view of the window 115, along with the top part of text object 105.

FIG. 2A illustrates the window 115 in the first position again. In FIG's 2A and 2B the indicators 1 60 are shown as tic marks, i.e., small line segments. In the embodiment these tic marks represent the tops of respective objects and are of various colors. The color of a tic mark shows what type of object the tic mark represents. In FIG's 2A and 2B the tic marks are labeled with letters, since FIG's 2A and 2B are black and white. However, it should be understood that the tic marked labeled “X” may be one color, such as red, while the tic mark labeled “I” may be another color, such as blue, and so on, according to one embodiment.

In FIG. 2A the scroll bar 120 and slider 140 are shown. In accordance with a well known convention, the portion of the information shown in the window 115 is represented by the slider 140 in the scroll bar 120. In another aspect of the invention, according to an embodiment, an indicator 160 is displayed in the slider 140 to represent a corresponding one of the objects shown in the window. Moreover, the position of the indicator 160 within the slider 140 indicates a position of the window 115 relative to the object. Specifically, with the window 115 in position 1, as shown in FIG. 2A, the entire object 102 is shown in the upper part of the window 115 and a top portion of object 103 in shown at the bottom of the window 115. Since there are two objects displayed in this position, positions of their corresponding indicators within the slider 140 indicate relative positions and sizes of the objects 102 and 103 within the displayed portion of information 150 (FIG. 1). Accordingly, the indicator 160 labeled “I” that represents object 102 is shown in the upper part of the slider 140, while the indicator 160 labeled “X” that represents object 103 is shown in the lower part of the slider 140.

FIG. 2B illustrates the window 115 in the second position. With the window 115 in this position the bottom portion of object 103 is displayed in the upper portion of the window 115. Since the top of object 103 is no longer in the window 115, the slider 140 does not include the indicator 160 labeled “X” for object 103. Also displayed with the window 115 in this position is the top part of object 104, shown in the bottom portion of the window 115. Therefore the indicator 160 labeled “T” is shown in the corresponding portion of the slider 140. Comparing FIG's 2A and 2B it may be seen that as the window 115 scrolls down through the information 150 (FIG. 1) the slider 140 correspondingly moves down through the indicators 160 and displays the appropriate ones of the indicators within the slider 140. This displaying of the indicators within the slider 140 applies not only when the slider has come to rest, but also while the slider is moving. That is, when the window 115 moves through the information, such as by the user dragging the slider, auto scrolling, clicking on one of the arrows in the scroll bar, etc., the indicators move through the slider 140 as the window scrolls through objects.

According to another aspect, if the slider 140 has only a single indicator in it, as in FIG. 2B, then the slider 140 changes to the same color as the indicator. Likewise, if the slider has no indicators in it, due to an object displayed in the window 115 being larger than the window and the window being positioned such that the indicator for the object is outside the slider, then the slider 140 changes to the same color as the indicator for the object that is displayed in the window.

As previously stated, in the embodiment of FIG's 2A and 2B the locations of the tic mark indicators represent the locations of the tops of the corresponding objects. Therefore, since the top of object 102 is at the top of the window 115 in FIG. 2A, the indicator 160 that represents the object 102 is at the top of the slider 140, and so on. In alternative embodiments, the locations of the indicators 160 represent the locations of some other portion of the respective objects. In one alternative, the locations of the indicators 160 represent the midpoints of the respective objects. In another alternative embodiment, the locations of the indicators 160 represent the endpoints of the respective objects.

FIG's 3A and 3B illustrate the same two positions of the window 115 as in FIG's 2A and 2B for another embodiment, in which indicators 160 for the information 150 objects are icons in the scroll bar 120, of a size proportionate to the size of the respective objects the indicators 160 represent. In an embodiment, the color of each indicator 160 indicates the type of object the icon 310 represents. (Since colors are not shown in the black and white illustrations of FIG's 3A and 3B, the icons are shown with labels “I,” “X,” “T,” etc. instead, to show which type of object each icon represents.) It is an advantage of the icon style indicator 160 of this embodiment that the icon shows both the beginning and end of the represented object. As in the embodiment illustrated in FIG's 2A and 2B, the position of the slider 140 relative to the indicators 160 shows the position of the window 115 relative to the positions of the objects, including not only the portion of the objects displayed within the window 115, but also the portions outside the window. This makes it clearer where the objects start and end relative to the current position of the window.

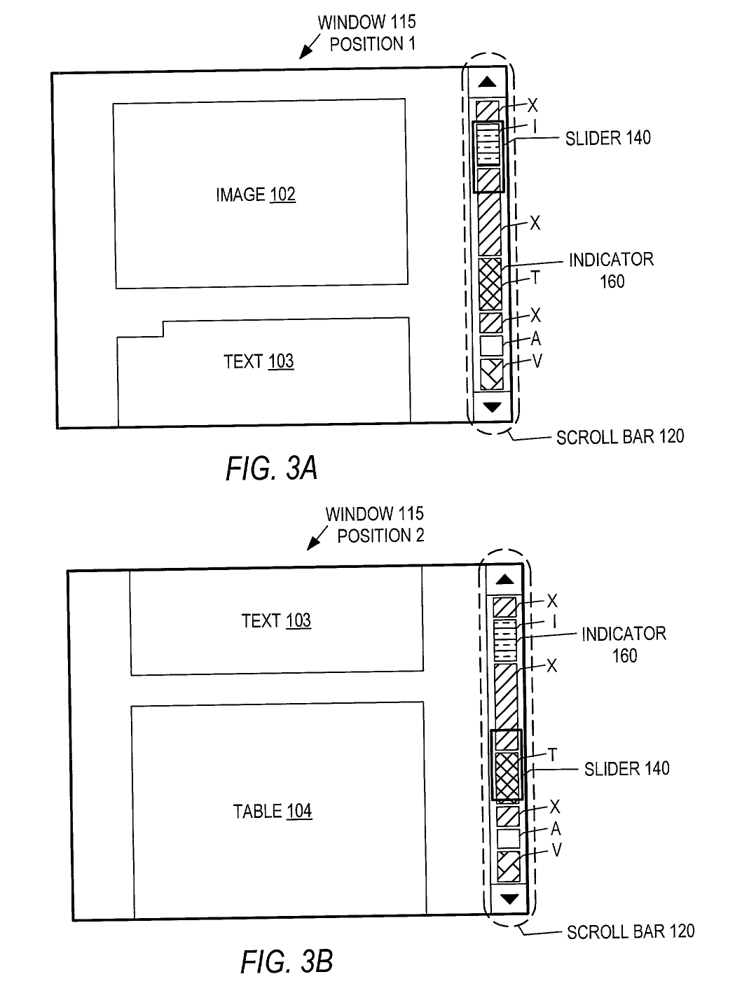

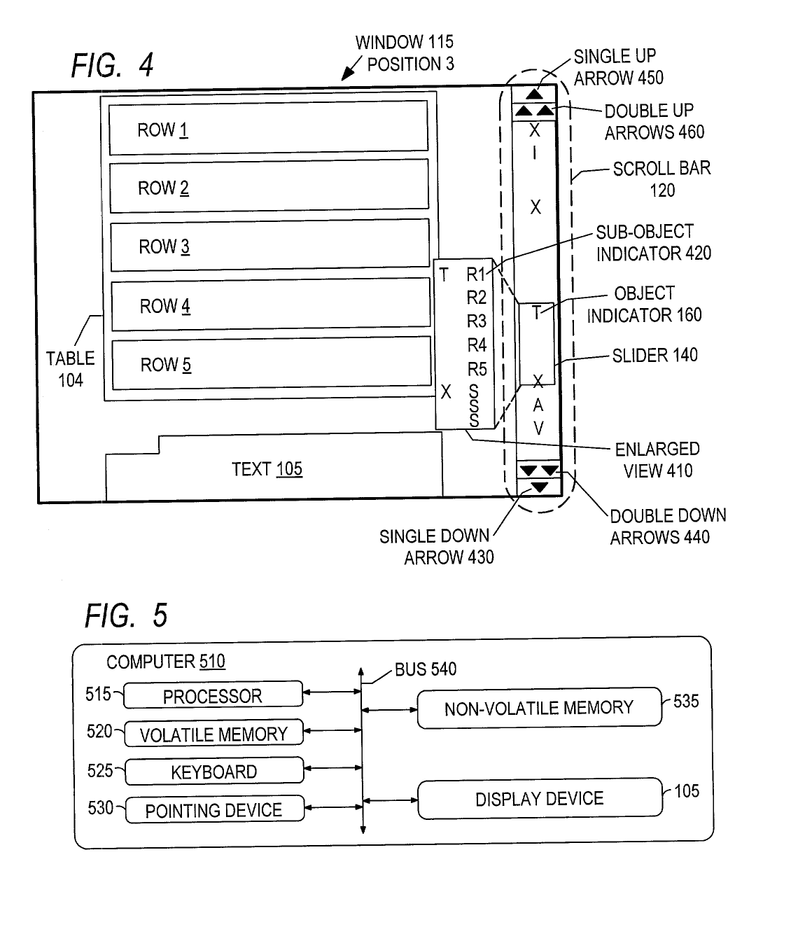

Referring now to FIG. 4, another aspect of the invention is illustrated, according to which an enlarged view of the slider is displayed responsive to a user command. The enlarged view includes an indicator 420 representing sub-objects. To display the enlarged view the user double clicks a pointer device (not shown) with the pointer on the slider 140, according to one embodiment.

In FIG. 4, the window 115 is in the third position, in which table object 104 is in the view of the window 115. The table 104 in this illustration has 5 rows, and in position 3 the window 115 shows the entire table 104. The enlarged view of the slider 140 shows sub-object indicators 420 of the table 104 for the five displayed rows of the table 104. The sub-object indicators 420 are shown as “R1” through “R5” for the rows of the table 104 and as “S's” for one of the sentences of the text 105, which serves to illustrate another aspect of the invention. In the illustrated embodiment, for objects and sub-objects which are numbered elements, such as the rows of table 104 in this illustration, the indicators 160 and 420 representing the respective objects are correspondingly numbered.

FIG. 4 also illustrates another aspect of the invention. It is conventional that if a user clicks the pointing device (not shown) with the pointer positioned above the slider 140, the window 115 scrolls up by the vertical length of one window 115. According to an embodiment of the present invention, if a user double clicks the pointing device with the pointer on one of the indicators 160 or 420, the window 115 immediately scrolls to the top of the indicated object or sub-object. For example, the window 115 would move to position 3, as illustrated in FIG. 4, responsive to a user clicking on the indicator 160 for table 104 in the scroll bar 120.

In an alternative to this embodiment, if the user single clicks (rather than double clicking, as in the previous embodiment) the pointing device with the pointer on one of the indicators 160 or 420, the window 115 immediately scrolls to the top of the indicated object or sub-object. At the bottom of window 115, in the scroll bar 120, is shown a single arrow 430 and double arrows 440 for scrolling downward. At the top of window 115, also in the scroll bar 120, is shown a single arrow 450 and double arrows 460 for scrolling upward. According to this alternative embodiment, in order to scroll the window up by the vertical length of one window 115, the user single clicks on double arrows 460. Likewise, in order to scroll the window down by the vertical length of one window 115, the user single clicks on double arrows 440.

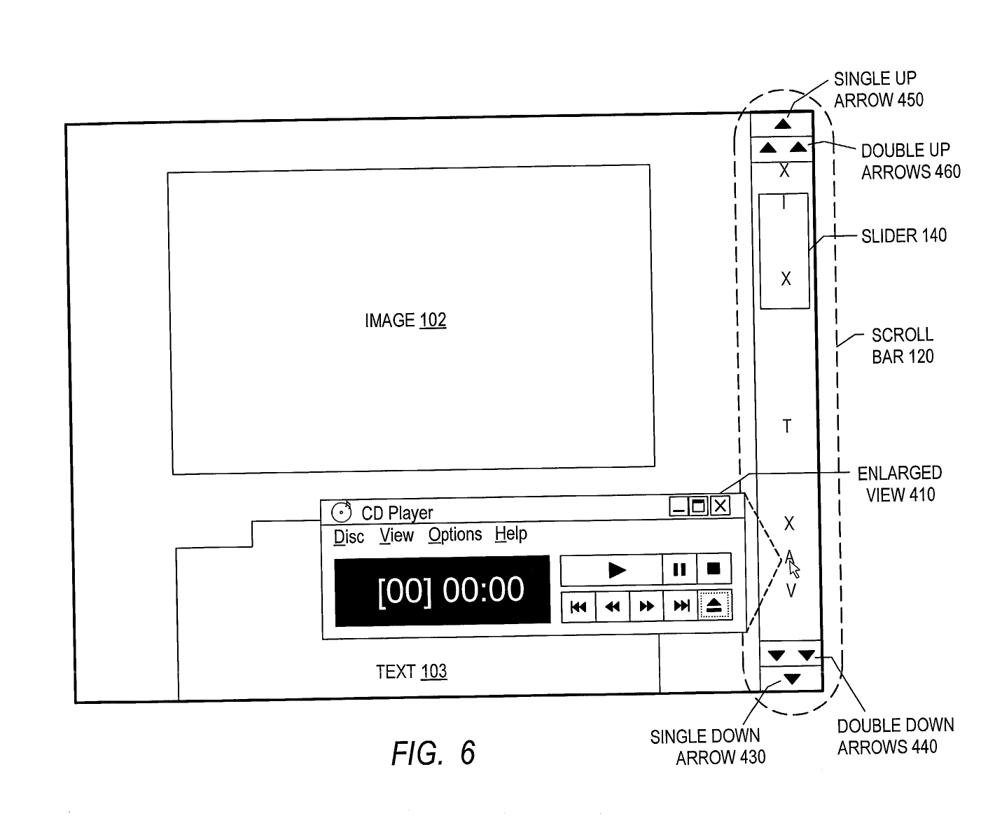

Referring now to FIG. 6, another aspect of the invention is illustrated, according to an embodiment. When the pointer is moved over an indicator in the scroll bar, information about the corresponding object can be made to pop up. In one alternative, the information pops up responsive to the user right clicking on a button of a pointing device. In the embodiment illustrated by FIG. 6, the user has moved the pointer over the indicator 160 for audio content 106 and right clicked. Accordingly, a control panel for the audio 106 has popped up in an enlarged view 410 of the indicator 160, as shown. In another aspect, information will pop up for a video clip in an enlarged view (not shown), including a list of topics which has links the user can select in order to go to more information about the selected topic.

Referring now to FIG. 5, a computerized device 510 is shown that is generally applicable for the embodiment described. The device 510 has a processor 515, a volatile memory 520 (that is, RAM), a keyboard 525, a pointing device 530, a nonvolatile memory 535 (for example, ROM, hard disk, floppy disk, CD-ROM, etc.), and a display device 105. The memory 520 and 535 are for storing a program for controlling the processor 515, and the processor is operative with the program to perform as described herein. The display device 105 shown could use a cathode ray tube (CRT), liquid crystal, field emission device, or some other type of display element. These components in the device 510 are interconnected by bus 540.

It is important to note that while the present invention has been described in the context of a fully functioning data processing system, those of ordinary skill in the art will appreciate that the processes of the present invention are capable of being distributed in the form of a computer readable medium of instructions in a variety of forms and that the present invention applies equally, regardless of the particular type of signal bearing media actually used to carry out the distribution. Examples of computer readable media include RAM, flash memory, recordable-type media, such a floppy disk, a hard disk drive, a ROM, and CD-ROM, and transmission-type media such as digital and analog communications links, e.g., the Internet.

The description of the present embodiment has been presented for purposes of illustration, but is not intended to be exhaustive or to limit the invention to the form disclosed. Many modifications and variations will be apparent to those of ordinary skill in the art. For example, downward scrolling is described in the examples used herein, but it should be understood that the description applies equally to horizontal or upward scrolling. Also while only a few types of objects have been illustrated, it should be understood that the invention applies to a wide variety of objects, including but not necessarily limited to one of the following objects: sections, divisions, rows, columns, cells, hypertext links, or pictorial images. According to one embodiment, in an application where the information includes an audio recording, audio objects have sub-objects which corresponds to pauses in the sound, verses, stanzas, refrains, interludes, movements, choruses, etc. In another embodiment, where the information includes an audio-video recording, audio-video objects have sub-objects which correspond to acts, scenes, commercials, sporting event quarters, halves, highlights, plays and time outs, etc. In another aspect, if a user creates a bookmark in the information, an indicator for the bookmark appears in the scroll bar.

In an additional aspect, since there are quite a number of types of objects for which indicators may appear in the scroll bar 120, in one embodiment a user preference selection menu is provided, according to which the user may selectively determine the types of objects for which indicators will appear. The user preferences selection menu also includes a default set of object types.

The invention also applies to a wide variety of programs for generating such display objects, including but not necessarily limited to any of the following application programs: word processor, web browser, spreadsheet, electronic book reader, multimedia player or data base applications. It should be understood that the invention is applicable to a wide variety of information besides documents created and edited by word processor applications. The invention is applicable to information including but not necessarily limited to the following: web pages, spreadsheets, databases, books, magazines, newspapers, audio content, and video content. In the embodiment shown in FIG. 1, seven indicators are shown in the scroll bar 120 to represent the seven objects shown in information 150. It should be understood that information 150 may have more objects than the seven which are illustrated, and that in one embodiment the indicators which are shown in the scroll bar 120 are limited to those which are proximate to the objects shown in the window 115 for its current position. In an alternative embodiment, the scroll bar displays indicators 160 for all objects 101, 102 etc. in the information 150 that is the current subject of the application running for the displayed window 115. This of course can result in a large number of indicators in the scroll bar 120, and therefore the tic mark type of indicators 160 are better suited to this embodiment. In one embodiment of the invention, an enlarged view of an area of the scroll bar pops up responsive to a user action. In one alternative, the magnified area pops up responsive to the user placing the pointer over the area of the scroll bar and right clicking a button of the pointer device. In this way, even if the indicators are very close together in the scroll bar, the user can see more detail about the indicators and distinguish among them.

To reiterate, the embodiments were chosen and described in order to best explain the principles of the invention and its practical applications, and to enable others of ordinary skill in the art to understand the invention. Various other embodiments having various modifications may be suited to a particular use contemplated, but may be within the scope of the present invention.

What is claimed is:

1. A method for indicating context for displayed information, comprising the steps of:
displaying in a window a first portion of information, wherein the window includes a scroll bar for controlling scrolling of the window through the information and the information includes a succession of objects; and
displaying indicators representing respective ones of the objects, including ones of the objects that are outside the first portion of the information that is displayed in the window, wherein the indicators are displayed in an area of the window, including an area within the scroll bar, and the displaying of such an indicator includes displaying of an attribute of the indicator, the attribute representing a type of the respective object represented by the indicator.

2. The method of claim 1, wherein the displayed attribute of the indicator is a color or a symbol.

3. The method of claim 1, wherein the object type is a text, table, audio, audio-video or image object type.

4. The method of claim 1, wherein the object type is a sentence, paragraph, section, division, chapter, page, hypertext link, row, column, cell, image, pause in sound, verse, stanza, refrain, interlude, movement, chorus, act, scene, commercial, quarter, half, highlight, play, time-out or bookmark object type.

5. The method of claim 1, wherein positions of the indicators represent relative positions of the objects within the information.

6. The method of claim 5, wherein at least a portion of one of the objects is within the first portion of the information that is displayed in the window, wherein the scroll bar comprises a slider, and wherein the method comprises the step of:
displaying an indicator in an area of the window including an area within the slider, wherein the indicator represents the at least portion of the one of the objects within the displayed first portion of the information, so that a position of the indicator within the slider indicates a position of the window relative to the at least portion of the object.

7. The method of claim 6, comprising the step of:
displaying an enlarged view of the slider responsive to a user command, wherein the enlarged view shows information for the object.

8. The method of claim 1 comprising the step of:
displaying an enlarged view of one of the objects responsive to a pointer being placed in the scroll bar over an indicator for the object.

9. The method of claim 8, wherein the information for the object includes a control panel for controlling the object.

10. The method of claim 1 comprising the step of:
scrolling the window to one of the objects responsive to the user clicking a pointing device with a pointer of the pointing device positioned on one of the indicators that represents the respective object.

11. The method of claim 1, wherein the types of objects for which respective indicators are displayed in the window are determined responsive to a user preference selection.

10. An apparatus for indicating context for displayed information, the apparatus comprising:
a processor;
a display device connected to the processor; and
a storage device connected to the processor, wherein the storage device is for storing a program for controlling the processor, and the processor is operative with the program to display in a window a first portion of information, wherein the window includes a scroll bar for controlling scrolling of the window through the information and the information includes a succession of objects, and display indicators representing respective ones of the objects, including ones of the objects that are outside the first portion of the information that is displayed in the window, wherein the indicators are displayed in an area of the window, including an area within the scroll bar, and the displaying of such an indicator includes displaying of an attribute of the indicator, the attribute representing a type of the respective object represented by the indicator.

11. The apparatus of claim 10, wherein the displayed attribute of the indicator is a color or a symbol.

12. The apparatus of claim 10, wherein the object type is a text, table, audio, audio-video or image object type.

13. The apparatus of claim 10, wherein the object type is a sentence, paragraph, section, division, chapter, page, hypertext link, row, column, cell, image, pause in sound, verse, stanza, refrain, interlude, movement, chorus, act, scene, commercial, quarter, half, highlight, play, time-out or bookmark object type.

14. The apparatus of claim 10, wherein positions of the indicators represent relative positions of the objects within the information.

15. The apparatus of claim 14, wherein at least a portion of one of the objects is within the first portion of the information that is displayed in the window, wherein the scroll bar comprises a slider, and wherein the processor is operative with the program to display an indicator in an area of the window including an area within the slider, wherein the indicator represents the at least portion of the one of the objects within the displayed first portion of the information, so that a position of the indicator within the slider indicates a position of the window relative to the at least portion of the object.

16. The apparatus of claim 15, wherein the processor is operative with the program to display an enlarged view of the slider responsive to a user command, wherein the enlarged view shows information for the object.

17. The apparatus of claim 10, wherein the processor is operative with the program to display an enlarged view of one of the objects responsive to a pointer being placed in the scroll bar over an indicator for the object.

18. The apparatus of claim 17, wherein the information for the object includes a control panel for controlling the object.

19. The apparatus of claim 10, wherein the processor is operative with the program to scroll the window to one of the objects responsive to the user clicking a pointing device with a pointer of the pointing device positioned on one of the indicators that represents the respective object.

20. The apparatus of claim 10, wherein the types of objects for which respective indicators are displayed in the window are determined responsive to a user preference selection.

21. A computer program product for indicating context for displayed information, the computer program product comprising:
instructions for displaying in a window a first portion of information, wherein the window includes a scroll bar for controlling scrolling of the window through the information, and the information includes a succession of objects; and
instructions for displaying indicators representing respective ones of the objects, including ones of the objects that are outside the first portion of the information that is displayed in the window, wherein the indicators are displayed in an area of the window, including an area within the scroll bar, and the displaying of such an indicator includes displaying of an attribute of the indicator, the attribute representing a type of the respective object represented by the indicator.

22. The computer program product of claim 21, wherein the displayed attribute of the indicator is a color or a symbol.

23. The computer program product of claim 21, wherein the object type is a text, table, audio, audio-video or image object type.

24. The computer program product of claim 21, wherein the object type is a sentence, paragraph, section, division, chapter, page, hypertext link, row, column, cell, image, pause in sound, verse, stanza, refrain, interlude, movement, chorus, act, scene, commercial, quarter, half, highlight, play, time-out or bookmark object type.

25. The computer program product of claim 21, wherein positions of the indicators represent relative positions of the objects within the information.

26. The computer program product of claim 25, wherein at least a portion of one of the objects is within the first portion of the information that is displayed in the window, wherein the scroll bar comprises a slider, and wherein the computer program product comprises:
instructions for displaying an indicator in an area of the window including an area within the slider, wherein the indicator represents the at least portion of the one of the objects within the displayed first portion of the information, so that a position of the indicator within the slider indicates a position of the window relative to the at least portion of the object.

27. The computer program product of claim 26 comprising:
instructions for displaying an enlarged view of the slider responsive to a user command, wherein the enlarged view shows information for the object.

28. The computer program product of claim 21 comprising:
displaying an enlarged view of one of the objects responsive to a pointer being placed in the scroll bar over an indicator for the object.

29. The computer program product of claim 28, wherein the information for the object includes a control panel for controlling the object.

30. The computer program product of claim 21 comprising:
instructions for scrolling the window to one of the objects responsive to the user clicking a pointing device with a pointer of the pointing device positioned on one of the indicators that represents the respective object.

31. The computer program product of claim 21, wherein the types of objects for which respective indicators are displayed in the window are determined responsive to a user preference selection.
